(19) United States
(12) Patent Application Publication
(10) Pub. No.: US 2013/0238773 A1
(43) Pub. Date: Sep. 12, 2013

(54) SYNCHRONIZED AND TIME AWARE L2 AND L3 ADDRESS LEARNING

(71) Applicant: Raghu Kondapalli, San Jose, CA (US)

(72) Inventor: Raghu Kondapalli, San Jose, CA (US)

(21) Appl. No.: 13/415,708

(22) Filed: Mar. 8, 2012

(51) Int. Cl. G06F 15/173

(52) U.S. Cl. 709/223

(57) ABSTRACT

Disclosed is a method for performing synchronized and time aware learning of network addresses and IP addresses in a networking environment. If a network machine is to be moved from a first server to a second server, a notification is sent to all of the network elements in the network. An entry is made into the address table of all of the network elements before the element is moved.

### BACKGROUND

In traditional network elements, especially Ethernet, networks operate in a self-operating way by learning about station moves, i.e. as all bridges and network elements learn Layer 2 Mac address. A Media Access Control (MAC) address is a unique identifier assigned to network interfaces for communications on the physical network segment. MAC addresses are used for numerous network technologies, including Ethernet. Although intended to be a permanent and globally unique identification, it is possible to change the MAC address on most modern hardware. Changing MAC addresses is necessary in network virtualization. It can also be used in the process of exploiting security vulnerabilities. Layer 2 switches us MAC addresses to restrict packet transmission to the intended recipient. However, the effect is not immediate (address learning). Many higher-end switches currently in distribution are Layer 3 switches. Such a switch supports IP multicast and therefore uses the IP address for routing. The switch preserves the MAC address for compatibility but does not need to use it for routing.

### SUMMARY

An embodiment of the invention may therefore comprise a method of learning a network machine address in a network environment. The network environment may comprise at least one network element and at least one network machine. The method may include the steps of, if a network machine is to be moved from a first server to a second server, sending a notification to all of the network elements of the at least one network element of the network machine move, making an entry into the address table of all of the network elements of the at least one network element of the network machine move and performing the network machine move.

An embodiment of the invention may further comprise a method of synchronized learning of a network machine address change in a network environment. The network environment may comprise a data center having a plurality of network elements. The method may include the steps of sending a message to all network elements in the network environment that one of said network elements will undergo an address move, updating an address table in each of said network elements that receives said notification and moving the network element that is to undergo the address move from a source address to a destination address.

An embodiment of the invention may further comprise a system for learning a network machine address in a network environment. The system may comprise a source virtual machine server element located at a first network address, at least one network switch element, and a destination virtual machine server at second address. An address change in the network environment results in moving virtual machine state information from the source virtual machine to the destination virtual machine and a notification is sent to the at least one network switch element. The notification provides information of the address change.

### BRIEF DESCRIPTION OF THE DRAWINGS

FIG. 1 is an embodiment of a block diagram of a virtual machine move.

FIG. 2 is an embodiment of a flow diagram of address learning.

FIG. 3 is an embodiment of a flow diagram of a method of synchronized address learning.

### DETAILED DESCRIPTION OF THE EMBODIMENTS

Whenever a station moves, the new location of the station is learned by all the network elements through which the data traffic traverses from the moved station. This is often referred to as source address based MAC learning. In order to not waste valuable hardware resources, the learned MAC addresses go through a process called aging which essentially invalidates the source MAC entry if no packet has been received for a certain period of time from that particular MAC station. In typical Ethernet networks, this time period is 5 minutes.

Similarly, in layer 3 or IP network elements, the routers learn IP addresses through a variety of learning protocols. In addition, there are protocols defined for cases where the MAC address is known for a station and not the IP address. This is called ARP learning. Accordingly, network elements leaning a variety of Layer 2 or Layer 3 addresses in known in the art.

An additional aspect of the network elements going through re-learning of MAC or IP addresses is handling failure events. A particular link in a network can possibly fail which in turn could affect other network elements downstream to that particular port. At a Layer 2, there are standard protocols defined and adopted by standards bodies. For example, Spanning Tree is a standards protocol that essentially helps eliminate network loops. It also handles the network link failure scenarios in terms of activating alternative paths for traffic to flow by bypassing the failed link. In the process of relearning Layer 2 or Layer 3 addresses there is always the possibility of other stations sending traffic to the station before it is either moved or an alternative path is defined. This is commonly referred to in the industry as a “blackhole”—where the stations new location is not completely learned by all the network elements. For inadvertent network link or station changes, e.g. due to failures, blackholes may be relatively common.

In network environments, it is also common that there are many administrative reasons why a network station or link needs to be moved from one physical or logical association to another part of either a corporate or service provider network. The solutions, protocols and procedures developed to date in the industry do not have efficient solutions for administrator scheduled network link or station changes. The same techniques of being able to slowly re-learn the addresses are adopted. So for bigger network level changes, the network administrator is required to send test packets out across various network elements so that each station is able to re-learn the new location. For scheduled maintenance or other changes, the term used is “outage” instead of a blackhole. However, the result is the same in terms of sent traffic resulting in an abundance of broadcasts and eventually the stations learn through these broadcasts. Eventually the network will regain a steady state.

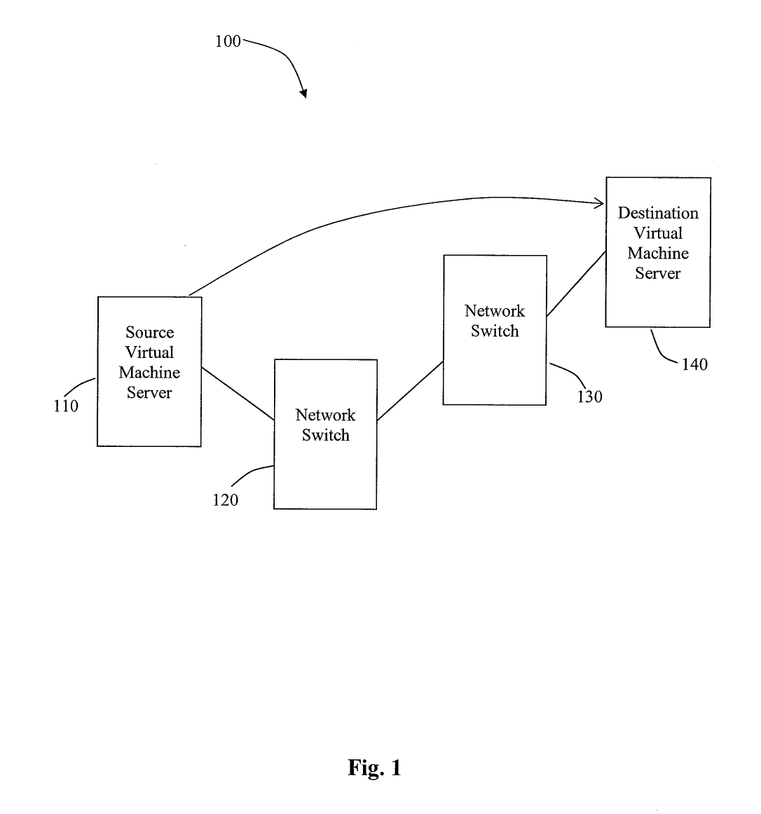

FIG. 1 is a block diagram of an embodiment of a virtualized machine move. The network system 100 shows a virtual 110 server move from a source virtual machine server 110 to a destination virtual machine server 140. As shown in the figure, two network switches 120,130 are connected to the virtual machine servers 110,140. An address change will result from the change from the source 110 to the destination 140. The network switches 120,130 will be unaware of the move from the source virtual machine server 110 to the destination virtual machine server 140. As such, the network switches will need to relearn the address of the destination virtual machine 140. This will create a blackhole for all traffic that was sent to the source server 110 until all of the network elements 120,130 learn the new location of the new virtual machine server 140. Virtualization software which may be aware of the move may coordinate the virtual machine move by configuring computational servers but not the network elements 120, 130 of the impending move.

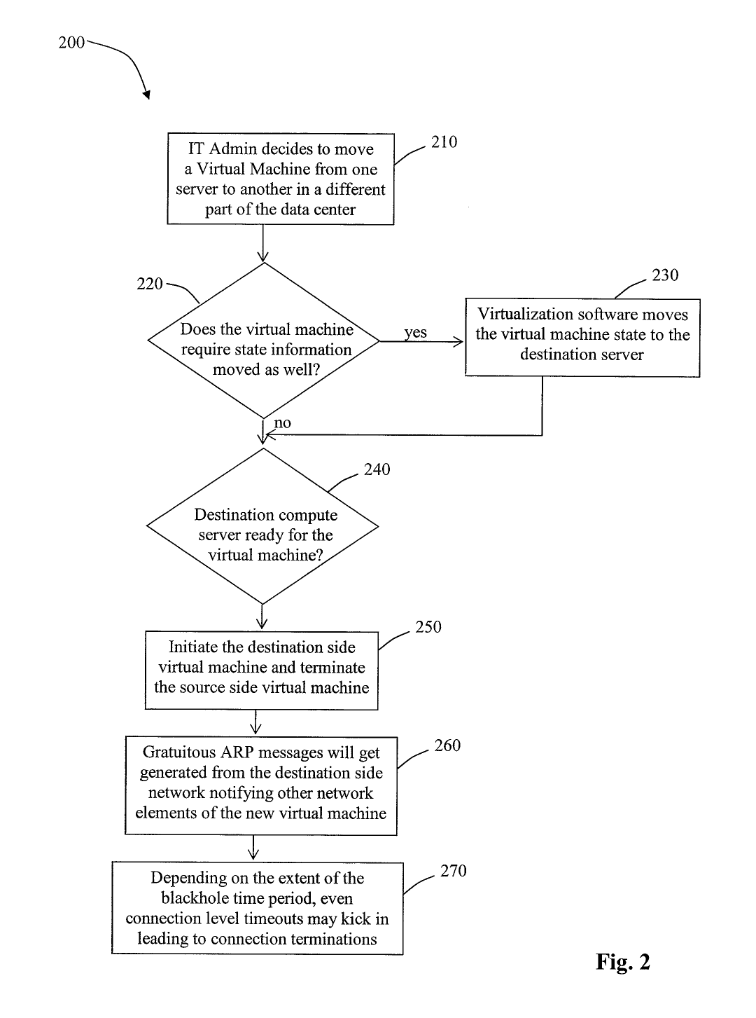

FIG. 2 is a flow diagram of an address learning method. As noted above, an IT admin may decide to move a virtual machine from one initial server to a destination server in a different part of the data center. This initial decision is shown in the first block 210. A decision block 220 will direct the method depending on whether the virtual machine requires state information moved in addition to location information. If yes, virtualization software will move the virtual machine state information to the destination server 230. Once the destination compute server is ready for the virtual machine 240, the destination side virtual machine is initiated and the source side virtual machine is terminated 250. At this point, the virtual machine move will have created a network blackhole, as discussed above, in terms of network hosts attempting to locate and communicate the virtual machine. This blackhole status will endure until all the network elements re-learn the new location of the virtual machine. Now, gratuitous ARP messages will be generated from the destination side network notifying other network elements of the new virtual machine 260. Depending on how long it takes for gratuitous RP messages to get generated and network elements to re-learn the new address, many data packets may be discarded and/or lost during the interim time period. The longer a blackhole lasts, the more critical the damage to information flow. Depending on the extent of the blackhole time period, connection level timeouts may occur. This may lead to connection terminations. Connection terminations will, of course, require the re-establishment of connections before the network can be effective again.

Network re-learn messages are scheduled and then generated from the control plane for various network elements that are affected by the particular physical or virtual changes. In routing, a control plane is the part of an architecture that is concerned with drawing the network map, or the information in a (possibly augmented) table that defines what to do with incoming packets. Control plane functions, such as participating in protocols, run the architectural control element. In most cases, the table contains a list of destination addresses and the outgoing interface(s) associated with them. Control plane logic also can define certain packets to be discarded, as well as preferential treatment. Virtual routers are an abstract representation of multiple routers, i.e. master and backup routers, acting as a group. A default gateway of a participating host may be assigned to the virtual router instead of a physical router. If the physical router that is routing packets on behalf of the virtual router fails, another physical router is selected to automatically replace it. The physical router that is forwarding packets at any given time is called the master router.

Before the station or virtual machine actually moves, the re-learn messages are sent out to the network elements which contain a time parameter or a flag indicating whether to follow a traditional learning process via broadcast or other control packet ping messages or to follow the time parameter to commit the new station or virtual machine's location.

A source network element also receives a control message indicating the time at which to erase the old entry and/or update the entry with the station or virtual machine's new location. This will ensure that the source network element, destination network element and all of the intermediate network elements commit the change of address information at the same time. Also, this will reduce address unknown broadcasts in a network. Broadcast packets in general bring down network performance and the method of the embodiment of the invention improves network performance.

An administrator will schedule a network element, station or virtual machine address change or move. Upon this scheduling event, short control message are sent out informing all relevant network elements with a message indicating the time period when the new location for the network element, station or virtual machine will be effective. It is understood, that the specified time period can be an absolute time (perhaps recovered from an IEEE 1588 network), some other timing protocol or a relative time from the point at which the message is received by the various relevant network elements. Although an absolute time may be more accurate than a relative time indication, an administrator could choose any indicator suitable to a particular policy.

This reduces resultant network blackhole issues. Further, the number of unknown broadcast messages related to a station or virtual machine move is reduced.

A Layer 2 address may be learned by bypassing the aging process described above. The aging process can be bypassed for specified entries to a fixed time interval either at the time when the address is learned or it can be specified at any time by the control plane to the data plane hardware engine which typically performs address learning.

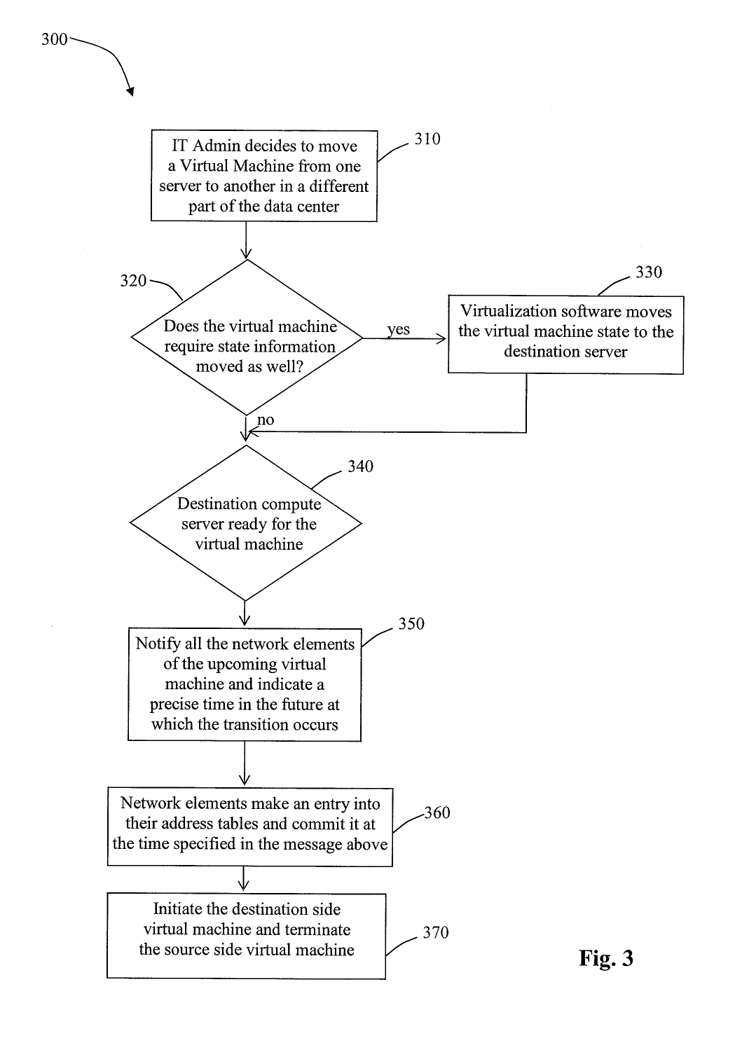

FIG. 3 is a flow diagram of a method of synchronized address learning. Similar to the method described in connection to FIG. 2, an IT Admin may decide to move a virtual machine from one server to another server in a different part of the data center 310. Accordingly, an address change will occur that will require re-learning by the network elements. Also, it will need to be determined if the new virtual machine requires state information to be moved as well 320. If so, then virtualization software will move the virtual machine state information to the new destination server 330. At this point, if the destination compute server is ready for the virtual machine 340, then a notification is sent to all the network elements 350. The notification will notify the network elements of the upcoming virtual machine move and indicate a precise time at which the transition will occur. The notification may comprise a control packet comprising the source virtual machine address, the destination virtual machine address and the time of the transition. All affected network elements will make an entry into their address tables in response to the notification 360. The network elements will commit the new destination address at the time specified in the notification. It is understood that network elements could be any element in a data center, including servers, routers and switches. The destination virtual machine will be initiated and the source virtual machine will be terminated at the specified time 370. The network elements will transition to the new destination virtual machine without any packet loss, or connection termination, due to a blackhole. Although the method described in FIG. 3 identifies virtual machine relocations, it is understood that the method described is also applicable for physical moves. Those skilled in the art understand the relationship between virtual and physical changes.

An embodiment of the invention may comprise a method and apparatus for performing synchronized and time aware learning of network MAC addresses and IP addresses in a networking cloud of many networking equipment items interconnected either over a layer 2 or a layer 3 network.

Blackhole and outage issues may be exacerbated in virtualized environments. This may be the case where the rate at which virtual machines migrate from one location to another is at a very high rate due to various administrative reasons. Typically, in the art, the virtual machine software (administrator) is aware of these virtual machine moves but does not assist the network elements in learning or migration. For example, gratuitous ARP messages may be sent after a destination station is established with the new virtual machine and all the network elements listen to the message to re-learn the station address. If the gratuitous ARP messages get dropped in the network element due to congestion or link failure, a prolonged blackhole period may ensue and may lead to transport level connection disconnects affecting the applications that are running on that particular machine.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of learning a network machine address in a network environment, said network environment comprising at least one network element and at least one network machine, comprising:
if a network machine is to be moved from a first server to a second server, sending a notification to all of the network elements of the at least one network element of the network machine move;
making an entry into the address table of all of the network elements of the at least one network element of the network machine move; and
performing the network machine move.

2. The method of claim 1, wherein said at least one network machine is a virtual machine and said machine move comprises moving the virtual machine from a source location to a destination location in the network environment.

3. The method of claim 1, wherein said at least one network machine is a virtual machine, said machine move comprises moving the virtual machine from a source location to a destination location in the network environment and said notification comprises a control packet comprising a source virtual machine address, a destination virtual machine address and a move time.

4. The method of claim 3, wherein said move time comprises an absolute time.

5. The method of claim 3, wherein said move time comprises a relative time.

6. The method of claim 7, wherein said network machine move comprises initiating a destination location and terminating a source location.

7. The method of claim 1, wherein said notification is a flag indicating a transition protocol.

8. The method of claim 7, wherein said transition protocol is a traditional learning process via broadcast.

9. A method of synchronized learning of a network machine address change in a network environment, said network environment comprising a data center having a plurality of network elements, comprising:
sending a message to all network elements in the network environment that one of said network elements will undergo an address move;
updating an address table in each of said network elements that receives said notification; and
moving the network element that is to undergo the address move from a source address to a destination address.

10. The method of claim 9, wherein said message comprises the source address for the network element undergoing a move, a destination address for the network element undergoing a move and a time for the move.

11. The method of claim 10, wherein said time is an absolute time.

12. The method of claim 10, wherein said time is a relative time.

13. The method of claim 10, wherein said step of moving the network element undergoing comprises initiating a destination element at the destination address and terminating a source address of the network element undergoing the move.

14. A system for learning a network machine address in a network environment, comprising:
a source virtual machine server element located at a first network address;
at least one network switch element; and
a destination virtual machine server at second address;
wherein an address change in the network environment results in moving virtual machine state information from the source virtual machine to the destination virtual machine and a notification is sent to the at least one network switch element, said notification providing information of the address change.

15. The system of claim 14, wherein said notification comprises a control packet, said control packet comprising the source virtual machine address, the destination virtual machine address and a time of the address change.

16. The system of claim 15, further comprising a control plane, wherein the notification is generated from the control plane.
